(19) United States
(12) Patent Application Publication
(10) Pub. No.: US 2024/0292932 A1
(43) Pub. Date: Sep. 5, 2024

(54) Laptop Cover and System for Closing

(71) Applicant: Connie Fiske, Medway, ME (US)

(72) Inventor: Connie Fiske, Medway, ME (US)

(21) Appl. No.: 18/664,734

(22) Filed: May 15, 2024

Related U.S. Application Data
(63) Continuation-in-part of application No. 17/566,215, filed on Dec. 30, 2021.
(60) Provisional application No. 63/135,192, filed on Jan. 8, 2021.

(51) Int. Cl. A45C 13/00; A45C 11/00; A45C 13/02; A45C 13/10; A45C 13/26; A45F 5/10; G06F 1/16

(52) U.S. Cl. CPC A45C 13/002; A45C 11/00; A45C 13/001; A45C 13/02; A45C 13/10; A45C 13/26; A45F 5/10; G06F 1/1628; A45C 2011/003; A45F 2200/0525

(57) ABSTRACT

A laptop cover is provided. The device includes a rigid housing including a base having a planar upper surface. A plurality of sidewalls extend from a perimeter of the base defining an open end opposite the base, wherein an interior volume of the housing is dimensioned to receive a laptop computer therein. A notch is disposed through one sidewall of the plurality of sidewalls, wherein the notch is dimensioned to receive a cable therethrough. The notch includes an open lower end extending through a distal end of the sidewall. In some embodiments, a storage compartment is disposed within the interior volume on an interior surface of the base. The laptop cover also includes an electromagnetic lock and a communications network that is controlled via a cell phone and mobile app, a mechanical switch, or a Radio Frequency Identification or RFID system.

### CROSS-REFERENCE TO RELATED APPLICATIONS

This U.S. Continuation-In-Part Patent application claims the benefit of U.S. Non-Provisional patent application Ser. No. 17/566,215 filed on Dec. 30, 2021, that claims the benefit of U.S. Provisional Patent Application No. 63/135,192 filed on Jan. 8, 2021. The above identified U.S. Continuation-In-Part Patent Application is herein incorporated by reference in its entirety to provide continuity of disclosure.

### BACKGROUND OF THE INVENTION

The present invention relates to a laptop cover. More particularly, the present invention pertains to a laptop cover and system for closing.

Many individuals utilize laptops, tablets, and other electronic devices on a regular basis, however, over time, such devices may become damaged when not properly stored in a carrying case or other storage location. Often times, individuals refrain from properly storing the portable device as they will be using it again shortly, and frequently storing and retrieving the device may become frustrating. However, leaving a device exposed on a table or other surface risks damage from various outside sources, such as pets, spills, falling objects, and the like. Furthermore, many such storage locations merely reduce the scope of damage caused to a portable device via impact, sustained weight, or other harmful activities with padding, rather than fully preventing it. Over time, even reduced damage may accumulate to potentially risk complete failure of the device.

Therefore, there is a need for a rigid cover capable of preventing weight and impact damage to a portable electronic device, while being relatively quickly and easily secured over the device between uses.

In light of the devices disclosed in the known art, it is submitted that the present invention laptop cover substantially diverges in design elements from the known prior art and consequently it is clear that there is a need in the prior art for an improvement to existing laptop covers. In this regard, the instant invention substantially fulfills these needs.

### SUMMARY OF THE INVENTION

In view of the foregoing disadvantages inherent in the known types of laptop covers and systems for closing the laptop covers now present in the prior art, the present invention provides a laptop cover and system for closing the laptop cover wherein the same may be utilized for providing convenience for the user when protecting a laptop or other portable computing device on a table or other support surface when the laptop is temporarily not in use.

The present system includes a rigid housing including a base having a planar upper surface. A plurality of sidewalls extend from a perimeter of the base defining an open end opposite the base, wherein an interior volume of the housing is dimensioned to receive a laptop computer therein. A notch is disposed through one sidewall of the plurality of sidewalls, wherein the notch is dimensioned to receive a cable therethrough. The notch further includes an open lower end extending through a distal end of the sidewall. In some embodiments, a storage compartment is disposed within the interior volume on an interior surface of the base.

It is an object of the present invention to provide a laptop cover and system for closing that is rectangular-shaped defining a front side and a rear side of identical length and a pair of lateral sides of identical length.

It is an object of the present invention to provide a laptop cover and system for closing that includes a handle that is affixed to a front sidewall of the plurality of sidewalls.

It is an object of the present invention to provide a laptop cover and system for closing that includes a flexible strap affixed to the front sidewall at opposing ends of the flexible strap.

It is an object of the present invention to provide a laptop cover and system for closing that includes a notch that is disposed through a lateral sidewall of the plurality of sidewalls.

It is an object of the present invention to provide a laptop cover and system for closing that includes the notch having an arcuate upper end.

It is an object of the present invention to provide a laptop cover and system for closing that includes a plurality of feet disposed along a lower surface of the plurality of sidewalls.

It is an object of the present invention to provide a laptop cover and system for closing that includes the plurality of feet having a material configured to frictionally engage a support surface.

It is an object of the present invention to provide a laptop cover and system for closing that includes a padded layer disposed about an exterior of the housing.

It is an object of the present invention to provide a laptop cover and system for closing that includes a storage compartment having a pocket extending between opposing lateral sides of the base.

It is an object of the present invention to provide a laptop cover and system for closing that includes a storage compartment that includes a plurality of cylindrical receptacles.

It is an object of the present invention to provide a laptop cover and system for closing that includes an electromagnetic lock that is controlled via a cell phone and mobile application, a mechanical switch, or a Radio Frequency Identification or RFID system.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of a system for using a laptop cover.

FIG. 2A shows a block diagram of a client system of the system for using a laptop cover.

FIG. 2B shows a block diagram of a server system of the system for using a laptop cover.

FIG. 3 shows a perspective view of an embodiment of a laptop cover.

FIG. 4 shows a partial cutaway side perspective view of an embodiment of a laptop cover.

FIG. 5 shows a lower plan view of an embodiment of a laptop cover.

FIG. 6 shows a perspective view of an embodiment of a laptop cover in use.

FIG. 7 shows a block diagram of an embodiment of a laptop cover.

### DETAILED DESCRIPTION OF THE INVENTION

Reference is made herein to the attached drawings. Like reference numerals are used throughout the drawings to depict like or similar elements of a system for using a laptop cover. The figures are intended for representative purposes only and should not be considered to be limiting in any respect.

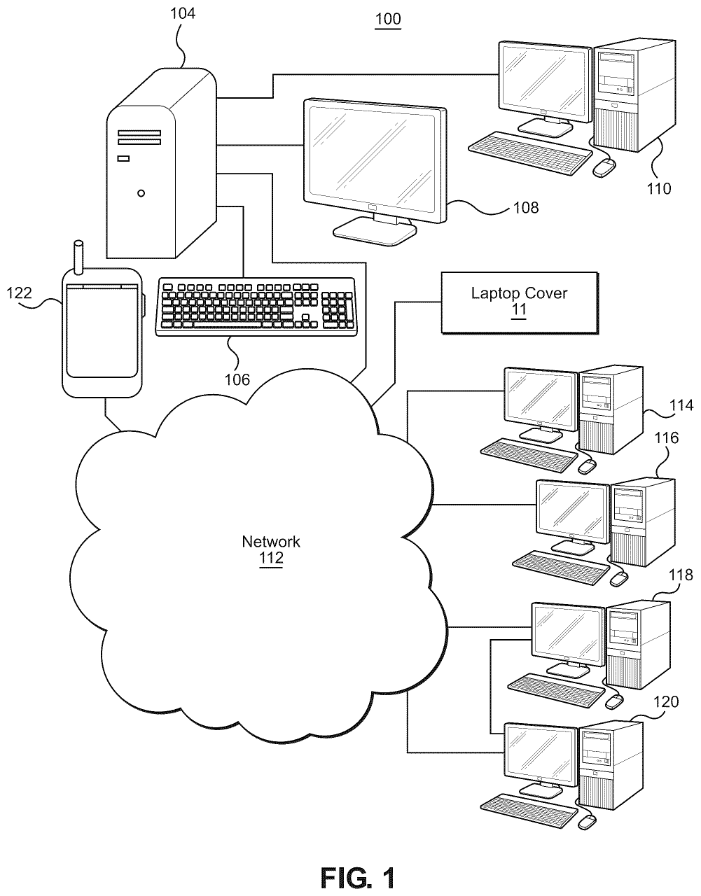

Referring now to FIG. 1 there is shown a system overview of a system for using a laptop cover 100.

The overall system 100 may include a server system 104, an input system 106, an output system 108, a plurality of client systems 110, 114, 116, 118 and 120, a communications network 112, a hand-held device 122, and a laptop cover 11. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 may illustrate some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 may be any system that an end user may use to access the server system 104. For example, the client systems 110, 114, 116, 118, and 120 may be personal computers, workstations, laptop computers, game consoles, handheld network enabled audio/video players and/or any other network appliance.

The client system 120 may access the server system 104 via the combination of the communications network 112 and another system, which in this example is the client system 118. The client system 120 may be example of a handheld wireless device 122, such as a mobile phone or a handheld network enabled audio/music player or the like, which may also be used for accessing network content.

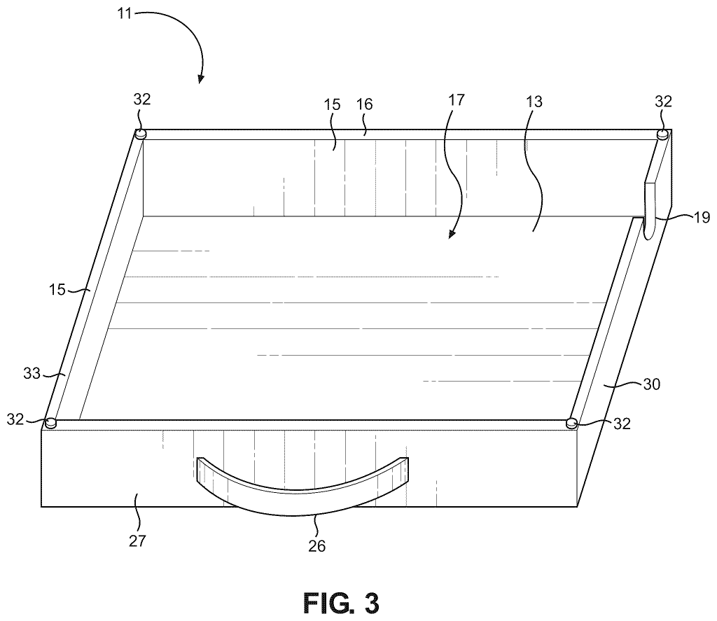

The laptop cover 11 may be in communication with the server system 104 via the communications network 112. The laptop cover 11 is described in more detail in FIGS. 3-7.

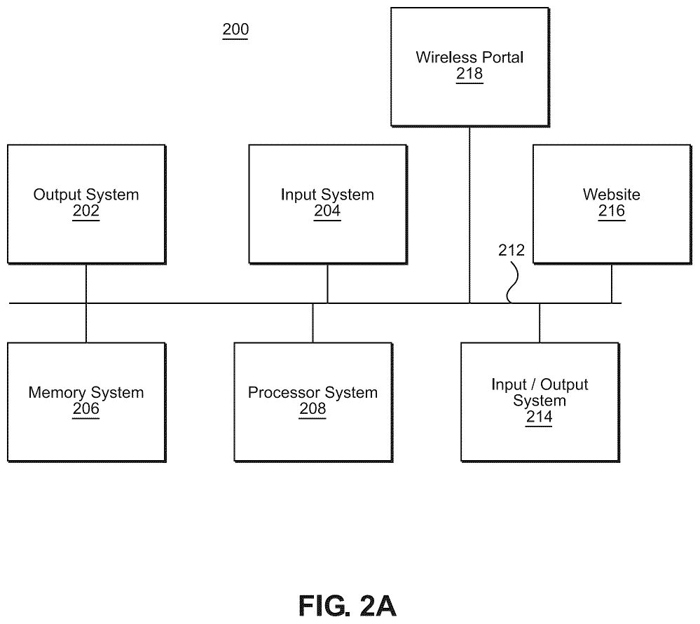

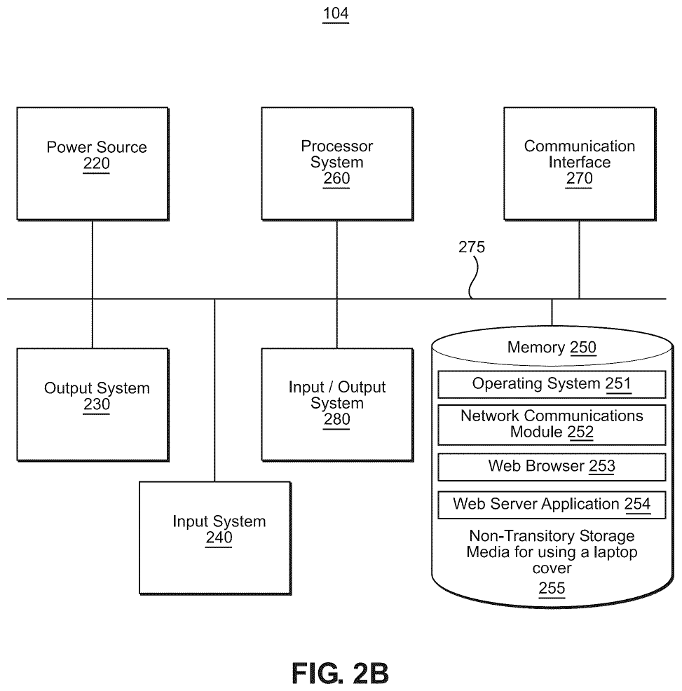

Referring now to FIG. 2A there is shown a block diagram of a client system 200 of a system for using a laptop cover 100.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a non-transitory storage media for using a laptop cover.

The processor system 208 may include any one of, some of, any combination of, or all of multiple parallel processors, a single processor, a system of processors having one or more central processors and/or one or more specialized processors dedicated to specific tasks. The processor system 208 may implement the programs stored in the memory system 206. The communications system 212 may communicatively button the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include software and a website module (no number) to maintain, allow access to and run the website as well.

FIG. 2B shows a block diagram of a server system 104 of the system for using a laptop cover 100.

The server system 104 may include a power source 220, an output system 230, an input system 240, a memory system 250, which may store an operating system 251, a communications module 252, a web browser module 253, a web server application 254, and a non-transitory storage media for using a laptop cover 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store one or more machine instructions for reading, searching and enhancing a system for closing a laptop cover 255. The operating system 251 may control all software or non-transitory storage media and hardware of the overall system 100. The communications module 252 may enable the server system 104 to communicate on the communications network 112. The web browser module 253 may allow for browsing the Internet. The web server application 254 may serve a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 may allow the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 may be optional and may be used in addition to or in place of the output system 230 and/or the input device 240.

Referring now to FIG. 3, there is shown a perspective view of an embodiment of a laptop cover.

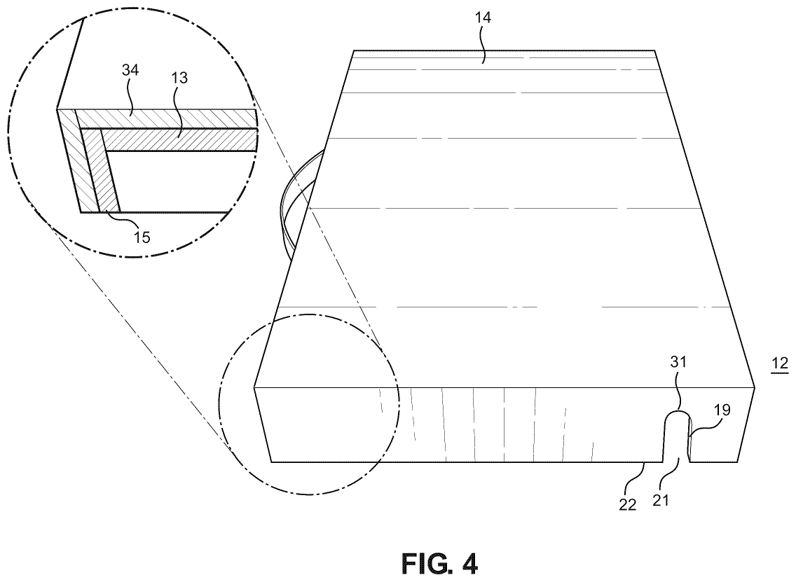

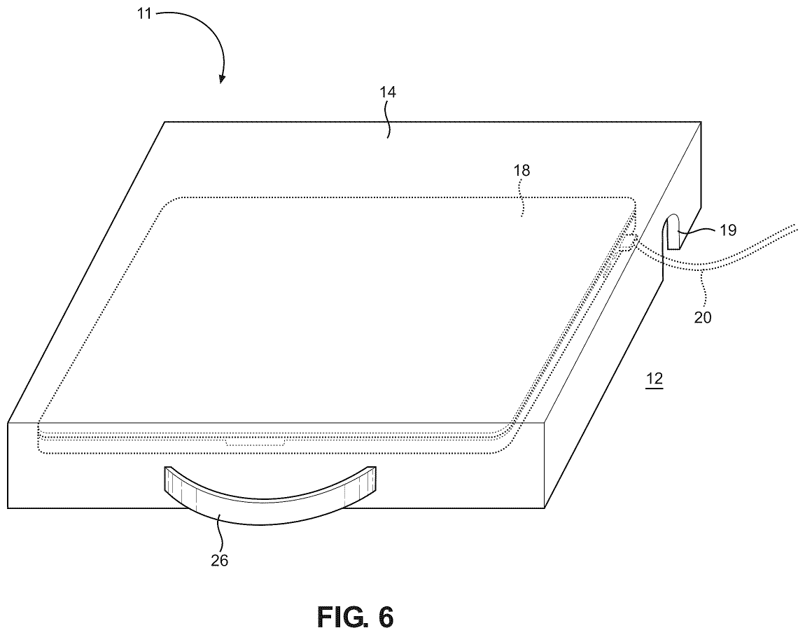

The laptop cover 11 may include a rigid housing having a base 13 and a plurality of sidewalls 15 extending perpendicularly from a perimeter of the base 13, defining an open end 16 opposite the base 13. In the illustrated embodiment, the base 13 may include a rectangular cross-section having a front side opposite a rear side and a pair of opposing lateral sides, wherein the pair of opposing lateral sides are of identical length and the front side is of an identical length as the rear side. In this manner, the laptop cover 11 may be dimensioned to enclose the stereotypical form factor of a laptop or other electronic device. An interior volume 17 may be defined between the base 13 and the plurality of sidewalls 15, wherein the interior volume 17 may be dimensioned to receive a portable electronic device (as shown in FIG. 6, 18), such as a laptop computer, tablet, or the like therein. In this manner, the rigid housing may be inverted over the portable electronic device 18 when not in use, such that the base 13 and the plurality of sidewalls 15 form a protective barrier between the portable electronic device 18 and the surrounding area. The rigid nature of the laptop cover 11 ensures that impact damage and sustained weight applied to the laptop cover 11 is not transferred to the underlying portable electronic device 18, thereby minimizing the risk of damage thereto. In the shown embodiment, the base 13 may further comprise a planar upper surface (as shown in FIG. 4, (14)), wherein the planar upper surface provides a flat and stable support surface for other items while the portable electronic device 18 is not in use.

The plurality of sidewalls 15 may include a notch 19 therein, wherein the notch 19 is disposed through a lateral sidewall 30 of the plurality of sidewalls 15. The notch 19 may be dimensioned to receive a power cable 20 therethrough, such that the portable electronic device 18 may be encased by the laptop cover 11 while still connected to an external power source. In this manner, the user may easily protect and charge their electronic device 18 simultaneously. The notch 19 is contemplated to be disposed through either or both of the lateral sidewalls 30 to facilitate use with various portable electronic device 18 designs wherein the power source may be connected to either side of the laptop. Furthermore, in the illustrated embodiment, a plurality of feet 32 are disposed about a lower surface 33 of each of the plurality of sidewalls 15, wherein the plurality of feet 32 are configured to frictionally engage a support surface to retain the laptop cover 11 over the portable electronic device. In some embodiments, the plurality of feet 32 comprise a rubber material increasing frictional engagement with the support surface, while minimizing the risk of damaging the support surface due to lateral shifting of the laptop cover 11. In the shown embodiment, the plurality of feet 32 are isolated to each corner of the laptop cover 11 at the intersection between adjacent sidewalls of the plurality of sidewalls 15. In this manner, the plurality of feet 32 prevent shifting from multiple independent directions while minimizing the material required to ensure frictional engagement. In the shown embodiment, a handle 26 may be affixed to a front sidewall 27 of the plurality of sidewalls 15, wherein the handle 26 provides a gripping surface to facilitate transport and use of the laptop cover 11. In the shown embodiment, the handle 26 comprises a flexible strap affixed to the front sidewall 27 on opposing ends of the handle 26.

Referring now to FIG. 4, there is shown a partial cutaway side perspective view of an embodiment of a laptop cover.

The notch 19 is disposed through the lateral sidewall to provide a passage through which the power cable 20 of the portable electronic device 18 may extend. The notch 19 extends through a distal end 22 of the lateral sidewall defining an open lower end 21 of the notch 19. In this manner, user may simply rest the laptop cover 11 over the electronic device 18 sitting on a relatively flat surface 12 while the power cable 20 is affixed thereto. In the shown embodiment, the notch 19 defines an arcuate upper end 31 opposite the open lower end 21, wherein the arcuate upper end 31 provides a smooth rounded shape to minimize the risk of damage to the power cable 20 via hard corners. Similarly, the sidewall along the edges of the notch 19 are contemplated to be rounded to minimize sharp corners which may damage the power cable 20 over extended contact.

In the illustrated embodiment, a padded layer 34 is affixed to an entire exterior of the laptop cover, wherein the padded layer 34 covers the planar upper surface 14 of the base 13 and the exterior surface of the plurality of sidewalls 15. In this manner, the padded layer 34 attenuates impacts occurring to the exterior of the laptop cover 11. Furthermore, the padded layer 34 provides a soft and comfortable surface for a user to rest arms thereon, or alternatively, for pets or other animals to rest upon while the portable electronic device 18 is safely covered. In some embodiments, the padded layer 34 further extends along an entire lower surface of the plurality of sidewalls 15 such that the padded layer 34 minimizes the risk of scratching or otherwise damaging the support surface. In this manner, the padded layer 34 serves a similar function to the plurality of feet as previously described.

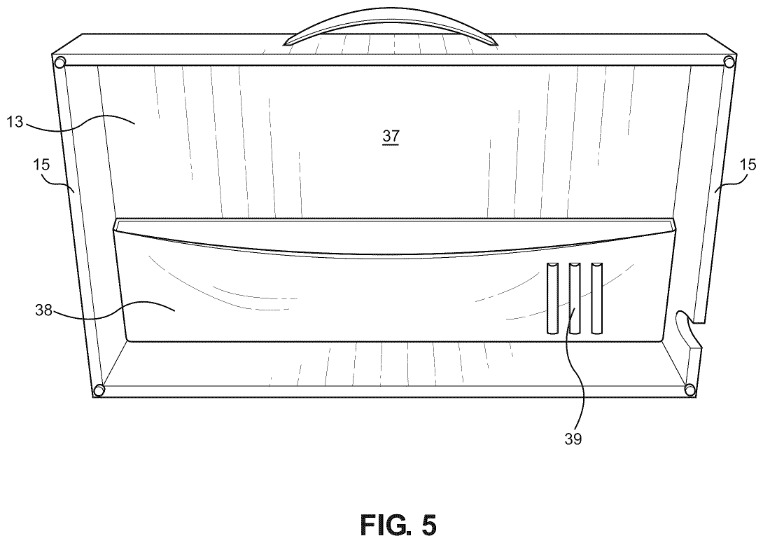

Referring now to FIG. 5, there is shown a lower plan view of an embodiment of a laptop cover.

In the illustrated embodiment, the laptop cover 11 further comprises a storage compartment on an interior surface 37 of the base 13. While alternate storage means are contemplated, such as elastic netting, retention clasps, or fasteners, in the shown embodiment, the storage compartment comprises a pocket 38 disposed across an entire length of the base 13. As the pocket 38 extends between opposing sidewalls of the plurality of sidewalls 15, the storage space provided thereby is maximized. The pocket 38 provides a storage receptacle for paperwork or other work-related accessories to aid a user in utilizing the electronic device. In the shown embodiment, a plurality of cylindrical receptacles 39 are disposed on an exterior surface of the pocket 38, wherein the plurality of cylindrical receptacles 39 are contemplated to retain writing utensils therein. In some embodiments, the plurality of cylindrical receptacles 39 are disposed on an interior surface of the pocket 38, or alternatively on the interior surface 37 of the base 13 within the interior volume of the pocket 38. In this manner, the plurality of cylindrical receptacles 39 and the associated writing utensils stored therein do not contact the laptop or other electronic device 18 while the laptop cover is in use, thereby reducing the risk of scratching or otherwise damaging the electronic device 18.

Referring now to FIG. 6, there is shown a perspective view of an embodiment of a laptop cover in use.

In one exemplary use, when a user wishes to stop using a laptop or other portable electronic device 18, the user may invert the laptop cover 11 over the portable electronic device 18 such that the portable electronic device 18 is disposed within the interior volume of the laptop cover 11. The user may ensure that the laptop cover 11 rests flush on the support surface by passing the power cable 20 of the portable electronic device 18 through the notch 19, allowing the plurality of sidewalls to rest parallel and flush with the support surface. In this manner, the planar upper surface 14 is parallel to the support surface, allowing a user to rest objects thereon and utilize the space occupied by the laptop cover 11 without damaging the portable electronic device 18. Once the user wishes to utilize the portable electronic device 18 again, the user may grasp the handle 26 to lift the laptop cover 11 from the support surface. In this manner, the laptop cover 11 provides a rigid, secure, and easily applied protective cover for a portable electronic device 18.

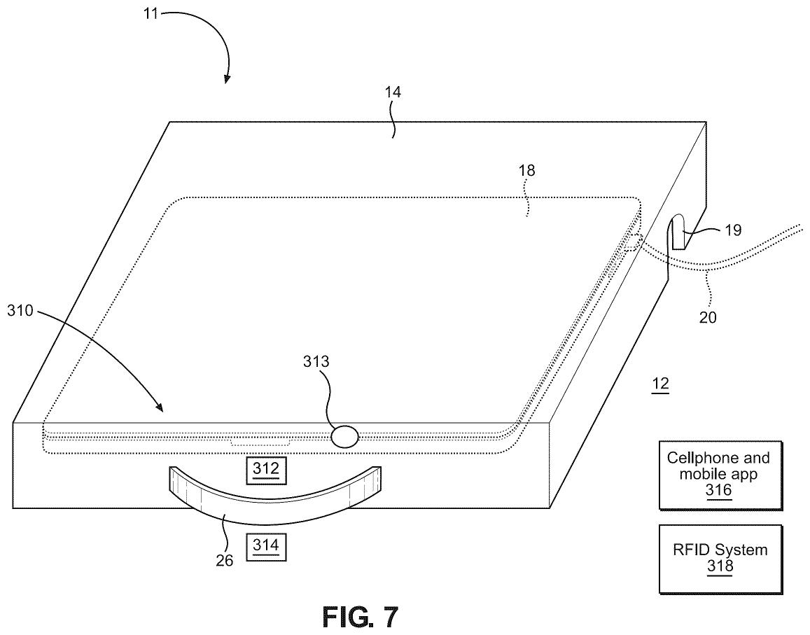

Referring now to FIG. 7, there is shown a perspective view of an embodiment of a laptop cover.

The laptop cover 11 may include an electromagnetic lock 310 and the communications network (FIG. 1, 112).

The electromagnetic lock 310 may include a first section 312 disposed on the front sidewall 27 of the plurality of sidewalls 15 and a second section 314 disposed on the relatively flat surface 12. The first section 312 may interlock with the second section 314 to couple the laptop cover 11 to the relatively flat surface 12 and be activated by a mechanical switch 313. The communications network 112 for the electromagnetic lock 310 may be controlled via a cell phone and mobile app 316 or a Radio Frequency Identification or RFID system 318 or the like.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system, comprising:
a server system with a processor system, a communications interface, a communications system, an input system and an output system, the server system having access to a communications network;
a memory system with an operating system, a communications module, a web browser module, a web server application and a non-transitory storage media for using a laptop cover, the memory system is in communication with the server system through the communications network; and
a laptop cover having a rigid housing including a base having a planar upper surface;
a plurality of sidewalls extending from a perimeter of the base defining an open end opposite the base;
wherein an interior volume of the housing is dimensioned to receive a laptop computer therein;
a notch disposed through one sidewall of the plurality of sidewalls;
wherein the notch is dimensioned to receive a cable therethrough;
wherein the notch includes an open lower end extending through a distal end of the sidewall; and
an electromagnetic lock coupling with having a first section disposed on disposed on the front sidewall of the plurality of sidewalls and a second section disposed on a flat surface.

2. The laptop cover of claim 1, wherein the base is rectangular, defining a front side and a rear side of identical length and a pair of lateral sides of identical length.

3. The laptop cover of claim 1, wherein a handle is affixed to a front sidewall of the plurality of sidewalls.

4. The laptop cover of claim 3, wherein the handle comprises a flexible strap affixed to the front sidewall at opposing ends of the flexible strap.

5. The laptop cover of claim 1, wherein the notch is disposed through a lateral sidewall of the plurality of sidewalls.

6. The laptop cover of claim 1, wherein the notch comprises an arcuate upper end.

7. The laptop cover of claim 1, further comprising a plurality of feet disposed along a lower surface of the plurality of sidewalls.

8. The laptop cover of claim 7, wherein the plurality of feet comprise a material configured to frictionally engage a support surface.

9. The laptop cover of claim 1, further comprising a padded layer disposed about an exterior of the housing.

10. The laptop cover of claim 1, wherein the first section interlocks with the second section to couple the laptop cover to the flat surface and be activated by a mechanical switch.

11. The laptop cover of claim 1, wherein the communications network is controlled via a cell phone and mobile app or a Radio Frequency Identification or RFID system.

12. A laptop cover, comprising:
a server system with a processor system, a communications interface, a communications system, an input system and an output system, the server system having access to a communications network;
a memory system with an operating system, a communications module, a web browser module, a web server application and a non-transitory storage media for using a laptop cover, the memory system is in communication with the server system through the communications network; and
a rigid housing including a base having a planar upper surface;
a plurality of sidewalls extending from a perimeter of the base defining an open end opposite the base;
wherein an interior volume of the housing is dimensioned to receive a laptop computer therein;
a storage compartment disposed within the interior volume on an interior surface of the base;
a notch disposed through one sidewall of the plurality of sidewalls;
wherein the notch is dimensioned to receive a cable therethrough; and
wherein the notch includes an open lower end extending through a distal end of the sidewall; and
an electromagnetic lock coupling with having a first section disposed on disposed on the front sidewall of the plurality of sidewalls and a second section disposed on a flat surface.

13. The laptop cover of claim 12, wherein the base is rectangular, defining a front side and a rear side of identical length and a pair of lateral sides of identical length.

14. The laptop cover of claim 12, wherein a handle is affixed to a front sidewall of the plurality of sidewalls.

15. The laptop cover of claim 14, wherein the handle comprises a flexible strap affixed to the front sidewall at opposing ends of the flexible strap.

16. The laptop cover of claim 12, wherein the notch is disposed through a lateral sidewall of the plurality of sidewalls.

17. The laptop cover of claim 12, wherein the notch comprises an arcuate upper end.

18. The laptop cover of claim 12, further comprising a plurality of feet disposed along a lower surface of the plurality of sidewalls.

19. The laptop cover of claim 16, wherein the plurality of feet comprise a material configured to frictionally engage a support surface.

20. The laptop cover of claim 12, further comprising a padded layer disposed about an exterior of the housing.

21. The laptop cover of claim 12, wherein the storage compartment comprises a pocket extending between opposing lateral sides of the base.

22. The laptop cover of claim 12, wherein the storage compartment includes a plurality of cylindrical receptacles.

23. The laptop cover of claim 12, wherein the first section interlocks with the second section to couple the laptop cover to the flat surface and be activated by a mechanical switch.

24. The laptop cover of claim 12, wherein the communications network is controlled via a cell phone and mobile app or a Radio Frequency Identification or RFID system.
